(19) United States
(12) Patent Application Publication
(10) Pub. No.: US 2015/0185043 A1
(43) Pub. Date: Jul. 2, 2015

(54) SHOE-BASED SENSOR SYSTEM FOR DETERMINING STEP LENGTH OF A USER

(71) Applicant: MOTOROLA MOBILITY LLC, Libertyville, IL (US)

(72) Inventor: Amit Jain, Mundelein, IL (US)

(73) Assignee: MOTOROLA MOBILITY LLC, Libertyville, IL (US)

(21) Appl. No.: 14/142,354

(22) Filed: Dec. 27, 2013

(51) Int. Cl. G01C 22/00; A43B 3/00

(52) U.S. Cl. CPC G01C 22/006; A43B 3/0005

(57) ABSTRACT

A method and apparatus for determining a step length of a user are disclosed. The method comprises transmitting, by a first sensor embedded in a first shoe, a signal to a second sensor embedded in a second shoe of the user, wherein the first sensor transmits the signal on being activated upon hitting a ground for a predetermined time period. The method further comprises measuring, at the second sensor, a signal strength of the received signal. Finally, the method determines, at the second sensor, the step length based on a transmission power of the first sensor and on the measured signal strength.

### TECHNICAL FIELD

The present disclosure is related generally to determination of a step length and more particularly to a shoe-based sensor system for determining the step length of a user.

### BACKGROUND

With increased consumer focus on health and wellness, there are many devices and applications that track the number of steps taken by a user in a day and provide estimates of the distance walked and calories burned in a day. These devices and applications also aim to provide an estimate of activity level of the user over a period of time. An important factor needed for calculation of these estimates is the step length of the user. Generally a default value for step length is picked based on the user profile, for example, gender, age, and height. However, such a default value may not be accurate and may result in inaccurate results.

### BRIEF DESCRIPTION OF THE SEVERAL VIEWS OF THE DRAWINGS

While the appended claims set forth the features of the present techniques with particularity, these techniques, together with their objects and advantages, may be best understood from the following detailed description taken in conjunction with the accompanying drawings of which:

FIG. 1 is generalized schematic model of a human walk;

FIG. 2 is a schematic representation of sensors embedded in shoes of a user in accordance with the some embodiments of the techniques;

FIG. 3 represents a block diagram of a first sensor in accordance with some embodiments of the present disclosure;

FIG. 4 represents a block diagram of a second sensor in accordance with some embodiments of the present techniques;

FIG. 5 is a flowchart of a representative method for determining a step length of a user; and

FIG. 6 is a block diagram representation of an electronic device in accordance with some embodiments of the present techniques.

### DETAILED DESCRIPTION

Turning to the drawings, wherein like reference numerals refer to like elements, techniques of the present disclosure are illustrated as being implemented in a suitable environment. The following description is based on embodiments of the claims and should not be taken as limiting the claims with regard to alternative embodiments that are not explicitly described herein.

Before providing a detailed discussion of the figures, a brief overview is given to guide the reader. Generally, in order to calculate the distance walked by a user, an important parameter to consider is the step length of a user. The existing methods provide an estimate of a step length of a user by selecting a default value based on various factors. However, such a default value may not be accurate and might provide inaccurate information to the user.

The present techniques provide a method and apparatus for determining the step length of a user. The present techniques are based on the principle that a signal strength of an electromagnetic wave decreases as the distance from transmitter increases. The system consists of a sensor embedded in each shoe of a user at a pre-defined but similar position in both shoes of a pair. As the user walks, the motion of the legs can be modeled as a swing of the legs from the hips. Further, as the legs swings, the relative distance between the legs changes. The position at which this relative distance is maximum is termed as the step length of the user.

Briefly, in a specific embodiment, one of the sensors is a transmitter and the other one is a receiver. The transmitter's transmission power (“Tx”) is fixed. The receiver queries the transmission power of the transmitter. Further, the receiver monitors the signal strength of a signal received from the transmitter. The difference of the transmission power and the received signal strength (“RSS”) gives the path loss. Further, once the path loss is known, the step length d can be calculated using the following equation:

Path loss (dB)=Tx−RSS=20 log 10(d)+20 log 10(f)−147.55

where log 10 is logarithm on base 10, d is step length (in meters), f is the frequency of signal in hertz. The maximum value of d determined using the above equation gives the maximum separation between the feet of the user and hence the step length of the user.

More generally, methods and apparatuses for determining a step length of a user are disclosed. The method comprises transmitting, by a first sensor embedded in a first shoe, a signal to a second sensor embedded in a second shoe of the user, wherein the first sensor transmits the signal on being activated upon hitting a ground for a predetermined time period. The method further comprises measuring, at the second sensor, a signal strength of the received signal. Finally, the method determines, at the second sensor, the step length based on a transmission power of the first sensor and on the measured signal strength.

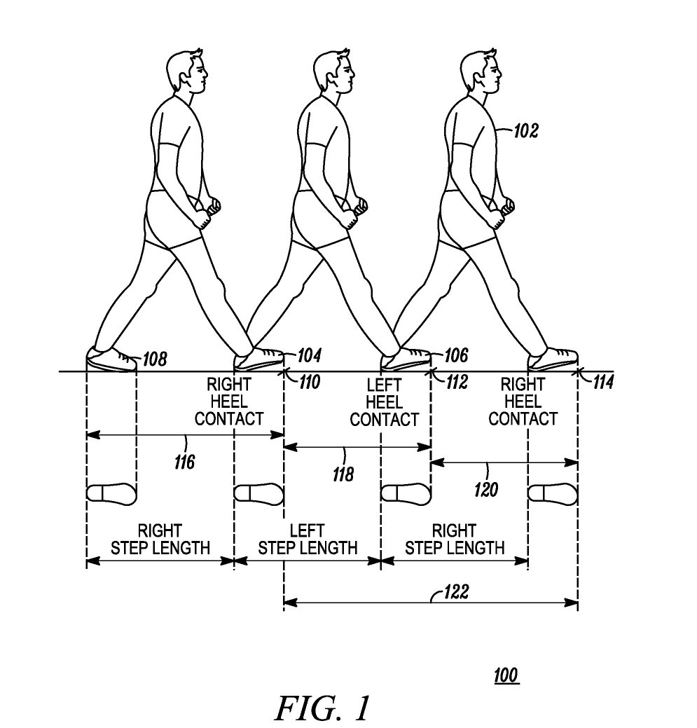

Turning now to drawings, and as described in detail below, one example of the present system is realized, although any suitable examples may be employed. A schematic of a model 100 of a human walk is illustrated in FIG. 1. The example model 100 represents a walking model of a user 102. As the user 102 walks, the motion of legs can be modeled as a swing of the legs from the hips of the user 102. When the user 102 starts walking, the right foot 104 hits the ground at the position 110 for some predetermined time period, for example fraction of seconds, and the left foot 106 is at the position 108, a farthest distance from the right foot 104. The distance 116 between the right foot 104 and the left foot 106 when they are farthest from each other is called the step length of the user 102. The distance 116 is also termed as a right step length.

Similarly, when the user 102 takes the next step after the predetermined time period, the right foot 104 stays at the position 110, and the left foot 106 moves to the position 112. The distance 118 between the right foot 104 and the left foot 106 at this position is termed the left step length. Moving further, the right foot 104 moves to the position 114, and the left foot stays at the position 112. The distance 120 between the left foot 106 and the right foot 104 is similarly termed the right step length. The left step length 118 and the right step length 120 are together termed the stride length 122 of the user 102.

Therefore, in accordance with the modeling of human walk, when the right foot hits the ground, the left foot is at a farthest distance from the right foot and is about to be lifted from the ground. The separation between the two feet at this instance is termed the step length of the user.

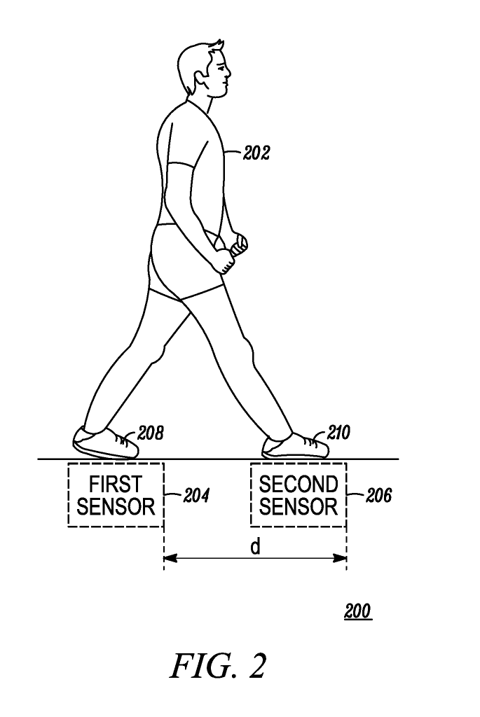

FIG. 2 depicts a user 202 and the representation of sensors embedded in shoes of the user 202 in accordance with the embodiments of the present techniques. In order to determine a step length of the user 102, sensors are embedded in each of the shoes of the user 202. For example, a first sensor 204 is embedded in a first shoe 208, and a second sensor 206 is embedded in a second shoe 210 of the user 202. It should be noted that both the first sensor 204 and the second sensor 206 are embedded at a pre-defined, but similar, position in both the first shoe 208 and the second shoe 210, respectively. In some embodiments, each of the first sensor 204 and the second sensor 206 is placed at a heel side of the first shoe 208 and the second shoe 210, respectively. In some embodiments, each of the first sensor 204 and the second sensor 206 is embedded towards the toe side of the first shoe 208 and the second shoe 210, respectively. One skilled in art would understand that the two positions of the sensors described above are for illustrative purposes only, and the other positions of the sensors within the shoes may be realized without departing from the scope of the present techniques.

As also described with respect to FIG. 1, the maximum relative distance d between the first foot 104 or the first shoe 208 and the second foot 106 or the second shoe 210 is termed the step length of the user 202. Because the first sensor 204 and the second sensor 206 are embedded in the first shoe 208 and the second shoe 210, respectively, the distance between the first sensor 204 and the second sensor 208 is the same as the step length of the user.

In accordance with the embodiments of the present techniques, the first sensor 204 and the second sensor 206 can include, for example, proximity sensors (e.g., a light-detecting sensor, an ultrasound transceiver, or an infrared transceiver), touch sensors, altitude sensors, Bluetooth devices, one or more location circuits, or other such devices well known in art.

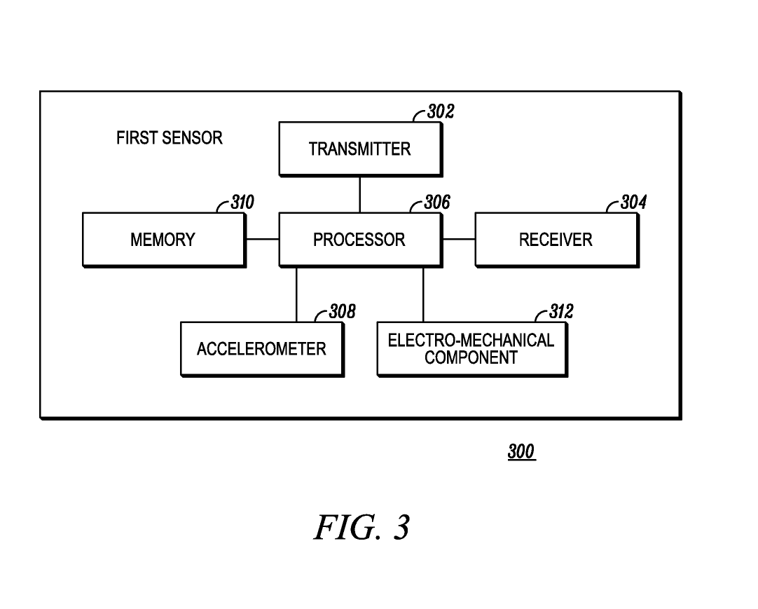

FIG. 3 is a schematic diagram of a sensor such as a first sensor 204 shown in FIG. 2. The sensor 204 includes a transmitter 302, a receiver 304, a processor 306, an accelerometer 308, a memory 310, and an electro-mechanical component 312. Although not shown, the first sensor 204 can include a system bus or data-transfer system that couples the various components within the first sensor 204. A system bus can include any combination of different bus structures, such as a memory bus or memory controller, a peripheral bus, a universal serial bus, and a processor or local bus that utilizes any of a variety of bus architectures.

In accordance with an embodiment, the transmitter 302 can be implemented as a transmitting component of the first sensor 204. The transmitter 302 enables the first sensor 204 to transmit radio-frequency (“RF”) signals through an antenna (not shown). In accordance with an embodiment, the receiver 304 can be implemented as a receiving component of the first sensor 204. The receiver 304 enables the first sensor 204 to receive RF signals through an antenna (not shown). In accordance with the embodiment, the receiver 304 converts the RF signals received from the antenna to digital data for use by the processor 306.

The memory 310 may be used to store data and instructions for the operation of the processor 306. In the various embodiments, the memory 310 may be one or more separate components or may be partitioned in various ways for various purposes such as, but not limited to, optimizing memory allocations, etc. Thus it is to be understood that the exemplary memory 310 illustrated in FIG. 3 is for illustrative purposes only, for the purpose of explaining and assisting one of ordinary skill in understanding the various embodiments described herein.

The first sensor 204 further comprises an accelerometer 308 configured to measure an acceleration value. In accordance with some embodiments, the accelerometer 308 measures an acceleration associated with the motion of the first foot 104 in the first shoe 208 in which the first sensor 204 is embedded. In some embodiments, the accelerometer 308 may be coupled separately with the first sensor 204 or be part of the first sensor 204 as shown in FIG. 3. Further, the processor 306 operates in conjunction with the data and instructions stored in the memory 310 to control the operation of the first sensor 204. The processor 306 may be implemented as a microcontroller, a digital signal processor, hard-wired logic and analog circuitry, or any suitable combination of these.

The first sensor 204 further comprises an electro-mechanical component 312 that provides power to the first sensor 204. In an embodiment, the electro-mechanical component 312 comprises a piezoelectric module. When the user is standing, the weight of the user is supported on the first foot 104. The mechanical stress applied is used as an input to the piezoelectric module which powers the sensor. Accordingly, the electro-mechanical component 312 powers the first sensor 204.

While the first sensor 204 for the purposes of FIG. 3 is considered to be constituted of different components, in other embodiments it is possible that one or more of the components are coupled to the sensor. It is to be understood that FIG. 3 is for illustrative purposes only and is not intended to be a complete schematic diagram of the various components and connections therebetween required for a sensor. Therefore, a sensor may comprise various other components not shown in FIG. 3, or may have various other configurations internal and external, and still be within the scope of the present disclosure. Also, one or more of these components may be combined or integrated in a common component, or components features may be distributed among multiple components. Also, the components of the first sensor 204 can be connected differently without departing from the scope of the present disclosure.

In operation, in an exemplary embodiment, the first sensor 204 is embedded in first shoe 208 worn on a first (for example, right) foot 104 of the user 102. When the first shoe 208 worn on the first foot 104 hits the ground, the accelerometer 308 determines an acceleration signal associated with the motion of the first foot 104. Based on the acceleration signal received from the accelerometer 308, the processor 306 determines that the first foot 104 has hit the ground. The processor 306 then instructs the transmitter 302 to start transmitting for a particular time period. The transmitter 302 could be programmed to transmit for a set period of time on being activated, for example it could transmit for 100 ms or for a second. In another embodiment, the transmitter 302 starts transmitting when the first shoe 208 hits the ground and stops transmitting when the first shoe 208 looses contact with the ground.

Therefore, in accordance with the embodiments of the present techniques, the first sensor 204 starts transmitting when the first foot 104 hits the ground. At this instance, the first foot 104 and the second foot 106 are a farthest distance apart from each other, and the distance at this moment is termed the step length of the user.

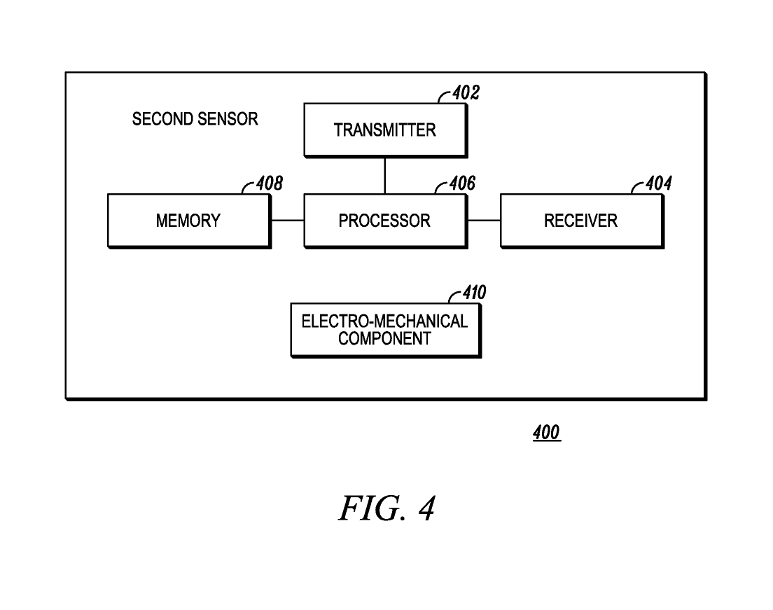

FIG. 4 is a schematic diagram of a sensor such as a second sensor 206 shown in FIG. 2. The second sensor 206 includes a transmitter 402, a receiver 404, a processor 406, a memory 408, and an electro-mechanical component 410. Although not shown, the second sensor 206 can include a system bus or data-transfer system that couples the various components within the second sensor 206. A system bus can include any combination of different bus structures, such as a memory bus or memory controller, a peripheral bus, a universal serial bus, and a processor or local bus that utilizes any of a variety of bus architectures.

In accordance with an embodiment, the transmitter 402 can be implemented as a transmitting component of the second sensor 206. The transmitter 402 enables the second sensor 206 to transmit RF signals through an antenna (not shown). In accordance with an embodiment, the receiver 404 can be implemented as a receiving component of the second sensor 206. The receiver 404 enables the second sensor 206 to receive RF signals through an antenna (not shown). In accordance with the embodiment, the receiver 404 converts RF signals received from the antenna to digital data for use by the processor 406. In an exemplary embodiment, the receiver 404 receives the signal transmitted by the transmitter 302 of the first sensor 204.

The memory 408 may be used to store data and instructions for the operation of the processor 406. In an exemplary embodiment, the memory 408 stores the transmission power of the transmitter 302 of the first sensor 204. In various embodiments, the memory 408 may be one or more separate components or may be partitioned in various ways for various purposes such as, but not limited to, optimizing memory allocations, etc. Thus it is to be understood that the exemplary memory 408 illustrated in FIG. 4 is for illustrative purposes only, for the purpose of explaining and assisting one of ordinary skill in understanding the various embodiments described herein.

Further, the processor 406 operates in conjunction with the data and instructions stored in the memory 408 to control the operation of the second sensor 206. The processor 406 may be implemented as a microcontroller, a digital signal processor, hard-wired logic and analog circuitry, or any suitable combination of these. In an exemplary embodiment, the processor 406 determines the step length of the user based on the transmission power as stored in the memory 408 and on a signal strength of the signal received by the receiver 404 from the first sensor 204.

The second sensor 206 further comprises an electro-mechanical component 410 that provides power to the second sensor 206. In an embodiment, the electro-mechanical component 410 comprises a piezoelectric module. When the user is standing, the weight of the user is supported on the second foot 106. The mechanical stress applied is used as an input to the piezoelectric module which powers the sensor. Accordingly, the electro-mechanical component 410 powers the second sensor 206.

While the second sensor 206 for the purposes of FIG. 4 is considered to be constituted of different components, in other embodiments it is possible that one or more of the components are coupled to the sensor. It is to be understood that FIG. 4 is for illustrative purposes only and is not intended to be a complete schematic diagram of the various components and connections therebetween required for a sensor. Therefore, a sensor may comprise various other components not shown in FIG. 4, or may have various other configurations internal and external, and still be within the scope of the present disclosure. Also, one or more of these components may be combined or integrated in a common component, or component features may be distributed among multiple components. Also, the components of the second sensor 206 can be connected differently without departing from the scope of the techniques.

It should be noted that although in the above description the first sensor is shown to be in the first shoe and the second sensor in the second shoe, however, one skilled in art would understand that the first sensor can be placed in the second shoe and vice versa and still be within the scope of present techniques.

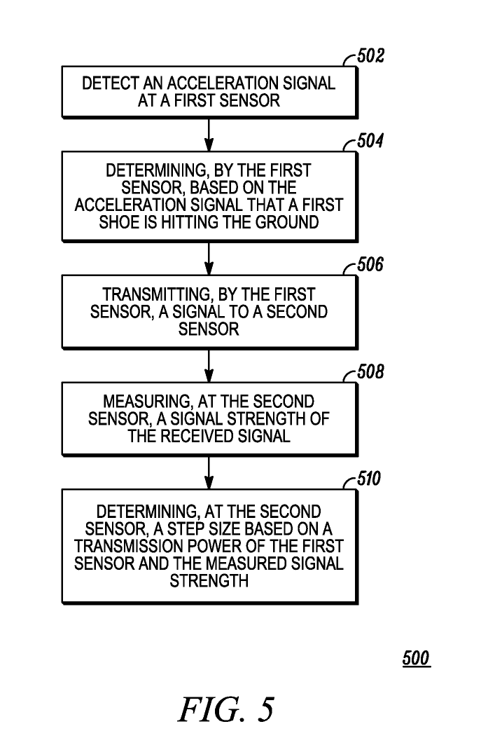

With this general background in mind, please turn to FIG. 5 which presents a representative method of a first sensor 204 and a second sensor 206 in accordance with some embodiments of the present techniques. The exemplary process 500 may be carried out by one or more suitably programmed controllers or processors executing software. The process 500 may also be embodied in hardware or a combination of hardware and software according to the possibilities described above. Although the process 500 is described with reference to the flowchart illustrated in FIG. 5, it will be appreciated that many other methods of performing the acts associated with process 500 may be used. For example, the order of many of the operations may be changed, and some of the operations described may be optional.

In general, when a user starts walking, the accelerometer 308 in the first sensor 204 detects 502 an acceleration signal. Based on the detected acceleration signal, the processor 306 determines 504 that a first shoe 208 has hit the ground. The processor 306 then instructs the transmitter 302 to start transmitting 506. Further, the receiver 404 of the second sensor 206 receives the signal from the first sensor 204. Accordingly, the processor 406 measures 508 the signal strength of the received signal. Further, based on the transmission power of the first sensor 204, which is stored in the memory 408 of the second sensor 206, and on the received signal strength, the processor 406 in the second sensor 206 calculates a path loss and further determines the step length of the user using the path loss 510.

More specifically, the example process 500 begins at step 502 when the first sensor 204 detects an acceleration signal. In some embodiments, when the user starts walking, the accelerometer 308 detects an acceleration associated with the motion of the user's foot. Precisely, the accelerometer 308 in the first sensor 204 models the motion of the user's foot. Further, based on the detected 502 acceleration, the processor 306 in the first sensor 204 determines at step 504 that a first shoe is hitting ground for a predetermined time period. The predetermined time period may be a fraction of seconds or any set time period stored in the memory 310.

The process 500 then proceeds to step 506 where the processor 306 instructs the transmitter 302 to transmit a signal to the second sensor 206. In fact, the processor 306 instructs the transmitter 302 to only transmit when it is determined that the first foot has hit the ground or in other words when the first foot and the second foot are a farthest distance apart from each other. This also helps to conserve energy because the transmitter 302 in the first sensor 204 only transmits when the first foot hits the ground. In that case, the second foot is at a farthest distance from the first foot, and the distance between the feet is at that instance the step length of the user. The transmitter 302 in the first sensor 204 could be programmed to transmit for a set period of time on being activated, for example, it could transmit for 100 ms or for a second. In another implementation, the transmitter 302 starts transmitting when the first shoe hits the ground and stops transmitting when the first shoe loses contact with the ground.

Further, the receiver 404 in the second sensor 206 receives the signal from the first sensor 204 and measures 508 a signal strength of the received signal. The signal strength refers to a magnitude of an electromagnetic field at a reference point that is a significant distance from the transmitting antenna. It may also be referred to as received signal level or field strength. In accordance with some embodiments, the signal strength represents the magnitude of the electric field of the signal received by the second sensor 206. In fact, the first sensor 204 starts transmitting only when two feet are a maximum distance apart from each other. The second sensor 206, therefore, calculates the signal strength of the signal when the first sensor 204 is at the maximum distance apart from the second sensor 206.

Further, the processor 406 in the second sensor 206 determines a step length of the user at the step 510. The transmission power Tx of the first sensor 204 is fixed and is stored in memory 408 of the second sensor 206. In some embodiments, the transmission power Tx of the first sensor 204 is known to the second sensor 206. In some embodiments, when the first sensor 204 transmits, a data packet transmitted from the first sensor 204 also contains the transmission power Tx of the first sensor 204. In some embodiments, the second sensor 206 queries the transmission power Tx of the first sensor 204. Once the transmission power Tx is known, the second sensor 206 starts monitoring the RSS for the signal received from the first sensor 204. The difference of the Tx and RSS gives the path loss. Given the path loss, the distance between the transmitter and receiver can be determined using the equation:

Path Loss (dB)=Tx−RSS=20 log 10(d)+20 log 10(f)−147.55

where log 10 is logarithm on base 10, d is step length (in meters), f is the frequency of the signal in hertz. The maximum value of d determined using this technique gives the maximum separation between the feet of the user, which is the step length of the user.

The step length of the user can be further utilized to calculate distance covered in a predetermined time period, the number of steps taken by the user, the speed of walking during the predetermined time period, etc. In some embodiments, the shoe-based sensor system comprising the first sensor 204 and the second sensor 206 can be used as a navigation aid as well. The first sensor 204 and the second sensor 206 can comprise a compass that determines the heading of a user. Once the starting point is known, the compass heading and distance calculations from the sensors can be used to provide location updates to the user as the user walks. Thus, once the step length of the user is know, various other calculations, as explained above, may be made.

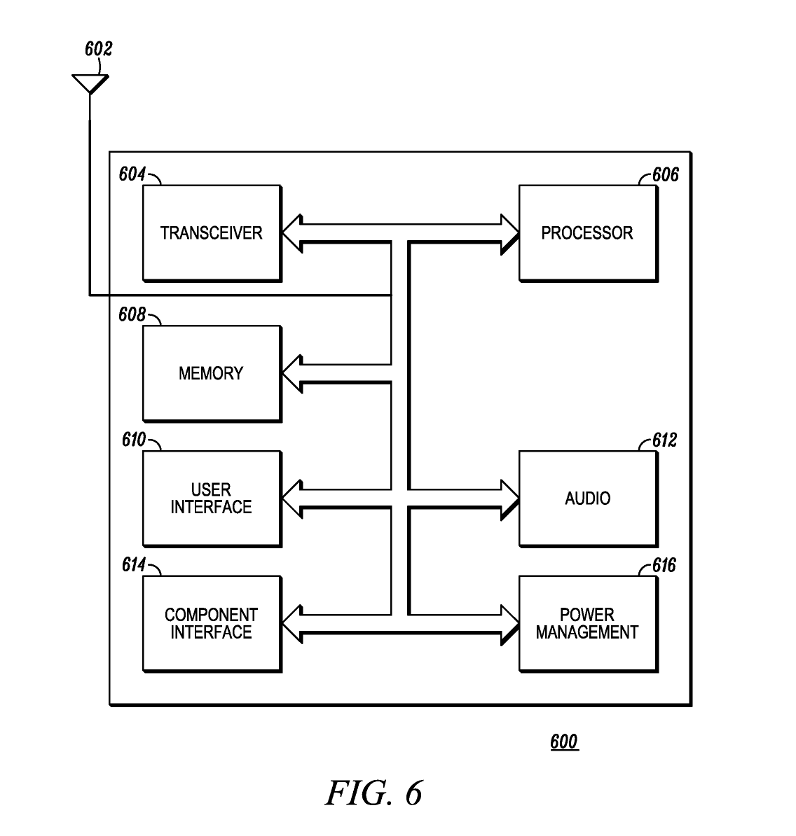

FIG. 6 illustrates an electronic device that can be used with the sensor-based system of the present techniques. The device 600 is meant to represent any computing device that presents visual information. It could be, for example, a personal communications device with a display screen, a mobile telephone, a personal digital assistant, or a personal or tablet computer. In some embodiments, the device 600 presents visual information to be displayed on a screen separate from the device 600 itself, such as a set-top box, gaming console, or server. The device 600 could even be a plurality of servers working together in a coordinated fashion.

The electronic device 600 includes a transceiver 604, which is configured for sending and receiving data. In a further example, the transceiver 604 is configured for receiving communications from the first sensor 204 and from the second sensor 206. The transceiver 604 is linked to one or more antennas 602. The electronic device 600 also includes a processor 606 that executes stored programs. The processor 606 may be implemented as any programmed processor and may be configured to operate with the different antennas and transceivers for the different 3G networks or other networks. However, the functionality described herein may also be implemented on a general-purpose or a special-purpose computer, a programmed microprocessor or microcontroller, peripheral integrated circuit elements, an application-specific integrated circuit or other integrated circuits, hardware logic circuits, such as a discrete element circuit, a programmable logic device such as a programmable logic array, field programmable gate-array, or the like.

The electronic device 600 further includes a memory 608. The processor 606 writes data to and reads data from the memory 608. The electronic device 600 includes a user-input interface 610 that may include one or more of a keypad, display screen, touch screen, and the like. The electronic device 600 also includes an audio interface 612 that includes a microphone and a speaker. The electronic device 600 also includes a component interface 614 to which additional elements may be attached. Possible additional elements include a universal serial bus interface. Finally, the electronic device includes a power-management module 616. The power-management module, under the control of the processor 606, controls the amount of power used by the transceiver 604 to transmit signals.

During operation, the transceiver 604 receives data from the processor 606 and transmits RF signals representing the data via the antenna 602. Similarly, the transceiver 604 receives RF signals via the antenna 602, converts the signals into appropriately formatted data, and provides the data to the processor 606. The processor 606 retrieves instructions from the memory 608 and, based on those instructions, provides outgoing data to, or receives incoming data from, the transceiver 604.

In an embodiment, the user interface 610 includes a display screen, such as a touch-sensitive display that displays, to the user, the output of various application programs executed by the processor 606. The user interface 610 additionally includes on-screen buttons that the user can press in order to cause the electronic device 600 to respond. The content shown on the user interface 610 is generally provided to the user interface at the direction of the processor 606. Similarly, information received through the user interface 610 is provided to the processor 606, which may then cause the electronic device 600 to carry out a function whose effects may or may not necessarily be apparent to a user.

Generally, a user may or may not be in direct physical contact with the electronic device 600. By way of example and not limitation, the user may, for example, hold the electronic device in his hand, fasten the electronic device to his body such as a hand, arm, leg, or waist, carry the electronic device in a bag or holder, or put the electronic device in a pocket.

In accordance with some embodiments, the electronic device 600 may be utilized by the user as a navigation tool with the help of the sensor-based system as explained above with. Further, the electronic device 600 may be programmed to display step length, distance, speed of the user, number of steps, etc., to the user.

In view of the many possible embodiments to which the principles of the present discussion may be applied, it should be recognized that the embodiments described herein with respect to the drawing figures are meant to be illustrative only and should not be taken as limiting the scope of the claims. Therefore, the techniques as described herein contemplate all such embodiments as may come within the scope of the following claims and equivalents thereof.

We claim:

1. A method for determining a step length of a user, the method comprising:
transmitting, by a first sensor embedded in a first shoe, a signal to a second sensor embedded in a second shoe of the user, wherein the first sensor transmits the signal on being activated upon hitting a ground for a predetermined time period;
measuring, at the second sensor, a signal strength of the received signal; and
determining, at the second sensor, the step length based on a transmission power of the first sensor and on the measured signal strength.

2. The method of claim 1 further comprising:
detecting an acceleration signal by an accelerometer coupled to the first sensor; and
determining, based on the acceleration signal, that the first shoe is hitting the ground for the predetermined time period.

3. The method of claim 1 wherein the transmission power of the first sensor in the first shoe is a fixed value known to the second sensor in the second shoe.

4. The method of claim 1 wherein determining the step length comprises:
calculating a path loss as a difference between the transmission power and the measured signal strength; and
determining the step length based on the calculated path loss.

5. The method of claim 4 wherein the step length is calculated using the equation:
PathLoss (dB)=20 log 10(d)+20 log 10(f)−147.55,
wherein d is the step length and f is the frequency of the signal.

6. The method of claim 1 further comprising:
calculating distance covered in another predetermined time period based on the determined step length.

7. The method of claim 6 further comprising:
calculating speed based on the calculated distance and on the other predetermined time period.

8. The method of claim 1 wherein the first sensor and the second sensor are embedded at predetermined positions in each of the first shoe and the second shoe, respectively.

9. The method of claim 1 wherein power to the first sensor and to the second sensor is provided using a first electro-mechanical component and a second electro-mechanical component, respectively.

10. A system for measuring a step length of a user, the system comprising:
a first sensor embedded in a first shoe worn by a user; and
a second sensor embedded in a second shoe worn by the user;
wherein the first sensor further comprises a transmitter configured to transmit a signal to the second sensor on being activated upon hitting a ground for a predetermined time period; and
wherein the second sensor further comprises a processor configured to measure a signal strength of the signal received from the first sensor and configured to determine the step length based on a transmission power of the first sensor and on the measured signal strength.

11. The system of claim 10 wherein the second sensor further comprises a receiver configured to received the signal from the first sensor.

12. The system of claim 10 wherein the first sensor further comprises:
an accelerometer configured to detect an acceleration signal;
wherein the first sensor is further configured to determine, based on the acceleration signal, that the first shoe is hitting the ground for the predetermined time period.

13. The system of claim 10 wherein the second sensor further comprises:
a memory configured to store the transmission power of the first sensor in the first shoe.

14. The system of claim 10 wherein determining the step length comprises:
calculating a path loss as a difference between the transmission power and the measured signal strength; and
determining the step length based on the calculated path loss.

15. The system of claim 14 wherein the processor is configured to calculate the step length using the equation:
PathLoss (dB)=20 log 10(d)+20 log 10(f)−147.55,
wherein d is the step length and f is the frequency of the signal.

16. The system of claim 10 wherein the processor is further configured to calculate distance covered in another predetermined time period based on the determined step length.

17. The system of claim 16 wherein the processor is further configured to calculate speed based on the calculated distance and on the other predetermined time period.

18. The system of claim 10 wherein the first sensor and the second sensor are embedded at predetermined positions in each of the first shoe and the second shoe, respectively.

19. The system of claim 10 wherein the first sensor and the second sensor comprise a first electro-mechanical component and a second electro-mechanical component to provide power to the first sensor and to the second sensor, respectively.
